(19) United States
(12) Patent Application Publication
(10) Pub. No.: US 2006/0008492 A1
(43) Pub. Date: Jan. 12, 2006

(54) Composition and method for delivering chemical agent to insects

(76) Inventors: Pablo Janowicz, Lenexa, KS (US); Antonio M. Baldan, Buenos Aires (AR); Valeria C. Baldan, Buenos Aires (AR); Fernando G. Baldan, Buenos Aires (AR); Alejandro J. Baldan, Buenos Aires (AR)

Correspondence Address: HOVEY WILLIAMS LLP, 2405 GRAND BLVD., SUITE 400, KANSAS CITY, MO, 64108, US

(21) Appl. No.: 10/888,164

(22) Filed: Jul. 9, 2004

(51) Int. Cl. A01N 25/00

(52) U.S. Cl. 424/405

(57) ABSTRACT

Compositions and methods for delivering chemical or biological agents, nutrients or hormones to insects, especially chemical and biological agents that are effective in treating or preventing diseases or parasites in beneficial insects such as honeybees. The compositions generally comprise an oil, a protein/carbohydrate material, and an active ingredient. The composition may be compressed and formed into tablets that are placed in locations where insects are likely to come into direct contact therewith.

### BACKGROUND OF THE INVENTION

1. Field of the Invention

The present invention generally relates to compositions and methods for delivering a chemical or biological agent to insects. More particularly, the invention pertains to a granular composition compressed into self-sustaining tablets comprising an active ingredient useful for treating and preventing diseases or parasites in and supplying nutritional substances to beneficial insects such as honeybees.

2. Description of the Prior Art

The keeping of beneficial insects, such as bees, is an important agricultural industry not only because of product directly derived from the insects, such as honey, but also because of the assistance the insects give in the pollination of other food crops. Various diseases and parasites, particularly mites, can be devastating to colonies of these beneficial insects. For example, one of the greatest threats to colonized bees is the Varroa mite.

Varroa mites attack both adult and immature honeybees by feeding on the bee's bodily fluids until the bee dies. Varroa mites are capable of spreading rapidly from one hive to the next and can be difficult to detect. In fact, it is possible for an infected hive to appear healthy and produce copious amounts of honey, only to suddenly die in the following months. The Varroa mites can also weaken the bee's immune system thereby making it more susceptible to other diseases such as viruses, European foulbrood, and American foulbrood.

To combat the Varroa mites, plastic strips containing a synthetic pyrethroid compound, fluvalinate, are hung between the brood frames of a bee hive. The strips should be removed after about 6 weeks so as to avoid contaminating the honey. For some time, this treatment was the only method available for combating the Varroa mites. As a result, some mites have become resistant to fluvalinate. To solve this problem, another treatment was devised. This treatment involves placing strips containing coumaphos into the hives. However, all of the same honey contamination concerns with fluvalinate are present with the coumaphos strips. In addition, both fluvalinate and coumaphos strips must be handled with caution (i.e., with rubber gloves) because of their toxicity.

As noted above, resistance to methods of treating Varroa mites is a growing concern. While the directions for use of the fluvalinate and coumaphos strips strictly state that the strips are to be removed from the hives after a certain length of time, it is often the case that these strips are left in the hives for much longer periods of time. This overexposure of the mites to fluvalinate and coumaphos is a major contributor to the development of resistant strains of mites.

Grease patties are another method used for delivering the active agent to the bees in the hive. Basically, the grease patties are made from solid shortening and white granulated sugar. The active ingredient is added to the shortening/sugar mixture and the mixture is formed into a hamburger-sized patty. As with the strips, in order to avoid overexposure of the mites to the active, the grease patty should be removed from the hive after a predetermined period of time. However, in actual practice, removal of the grease patty is messy and rarely performed.

There is a real and unfulfilled need in the art for a composition and method for delivering a chemical agent that is easy to handle and that does not need to be manually removed from the hive after a certain period of time thereby reducing the opportunity for development of resistant strains of mites.

### SUMMARY OF THE INVENTION

The present invention overcomes the above problems and provides compositions for delivering a chemical and biological agent to insects. Compositions according to the present invention are generally in the from of a solid tablet and comprise (and preferably consist essentially of) an oil, a protein/carbohydrate material (preferably vegetable based), a sweetener and an active ingredient useful in the prevention or treatment of diseases in insects.

Preferably, compositions according to the present invention are essentially free of synthetic resin material. As used herein, the term “essentially free” is defined as meaning that if the stated component is present in the composition, its presence does not impart any meaningful property or characteristic to the composition. In particularly preferred embodiments, the composition comprises less than about 0.1% by weight, and more preferably less than about 0.05% by weight, of synthetic resin material.

Solid tablets according to the invention generally comprise granules that are compressed into a self-sustaining body. As used herein, the term “self-sustaining” means that the body retains a particular shape once that shape is formed and is not susceptible to deformation merely due to its own internal forces. This definition specifically excludes gels and pastes from being considered “self-sustaining bodies.” The granular nature of the solid tablets permits the tablets to crumble up exertion of sufficient force on the tablet, for example, through the chewing action of the insects.

The active ingredient used with the tablets will vary depending upon a particular need. The inventive tablets may be used in the treatment of a broad range of insect diseases, disorders, and parasites especially Varroa mites, tracheal mites, American foulbrood, European foulbrood, Chalkbrood, Sacbrood, and Nosema. Also, the tablets can be used to deliver nutrients and hormones to the insect. Preferred antiparasitic compositions for use herewith include fumagillin, amitraz, trimethoprim, monensin, nicarbazin, metoclopramide, and norfloxacin. Preferred antibiotic agents include tetracycline, chlorotetracycline, oxytetracycline and tylosin. Various pesticides such as chlorinated and phosphorous organic pesticides and carboxylic acids can also be used. Preferred pesticides include co-ral, coumaphos, thymol, rotenone, tetramethrin, decamethrin, permethrin, deltamethrin, cypermethrin, fluvalinate, pyrethrin, oxalic acid, lactic acid, formic acid, cimiazol and various essential oils. Mixture of any of the foregoing active ingredients can be used. This list of active ingredients is non-exclusive and should not be interpreted as limiting the scope of the invention to just those named active agents.

The quantity of active ingredient used in the tablets also greatly depends upon the specific agent employed. Preferably, however, the tablets comprise from about 0.001-25% by weight of the active ingredient, more preferably from about 0.01-10% by weight, and most preferably from about 0. 1-5% by weight. All weight percentages expressed herein are based on the weight of the entire composition unless otherwise stated.

Tablets according to the present invention comprise from about 4-40% by weight of an oil, more preferably from about 10-30% by weight, and most preferably from about 15-25% by weight. As used herein, the term “oil” means plant oil, petroleum derived oils, and other water immiscible hydrocarbons including but not limited to parrafins. Preferred oils include plant and vegetable oils such as corn, sunflower, peanut, olive, grape seed, tung, turnip, soybean, cotton seed, walnut, palm, castor, earth almond, hazelnut, avocado, sesame, croton tiglium, cacao, linseed, rape-seed, and canola oils and their hydrogenated derivatives. Preferred non-plant or vegetable oils include parrafins and petroleum jelly (i.e., Vaseline™). The oils noted above can be used alone or in combination with each other. For example, tablets according to the invention may comprise both corn oil and parrafin.

The tablets further comprise from about 5-40% by weight of a vegetable-based protein/carbohydrate material, more preferably from about 10-35% by weight, and most preferably from about 15-30% by weight. As its name suggests, the material comprises both a carbohydrate portion and a protein portion. While the relative fraction of each portion making up the material may vary, the material should include at least a portion of carbohydrate and protein. The protein/carbohydrate material is preferably derived from cereal grains such as wheat, rye, barley, oat, corn, rice, millet, sorghum, birdseed, buckwheat, alfalfa, and mielga. More preferably, the protein/carbohydrate material is selected from the group consisting of corn meal, soybean meal, grain flour, wheat middlings, wheat bran, corn gluten meal, algae meal, dried yeast, beans, rice and combinations thereof, with corn meal being most preferred.

The tablets also comprise from about 25-75% by weight of a sweetner, more preferably from about 37-70% by weight, and most preferably from about 45-65% by weight. As used herein, the term “sweetner” generally refers to both natural and artificial sweeteners. Preferably, the sweetener is a sugar such as glucose, fructose, sucrose, galactose, lactose, and reversed sugar. The sugar is preferably selected from the group consisting of granulated sugar (white sugar), brown sugar, confectioner's sugar, impalpable sugar, icing sugar, and combinations thereof. Alcohols such as glycerin and complex carbohydrates such as starches may also be used as the “sweetener” ingredient. The sweetener is used primarily as an attractant for the insects, however the sweetener also helps to impart a granular structure to the tablets, especially when the sweetener is a sugar. As previously discussed, this granular structure permits the tablet to crumble over time upon the exertion of sufficient forces.

Optionally, various excipients and binders can be used in order to assist with delivery of the active ingredient or to provide the appropriate structure to the tablet. Preferred excipients and binders include anhydrous lactose, microcrystalline cellulose, corn starch, magnesium estearate, calcium estearate, zinc estearate, sodic carboxymethylcellulose, ethyl cellulose, hydroxypropyl methyl cellulose, and mixtures thereof.

Tablets according to the present invention are manufactured by mixing all of the ingredients together and then compressing the mixture into a tablet of desired shape and size for a particular application. Preferably, the tablet is discoid in shape with a diameter of between about 2-5 inches and a thickness of from about 0.5-2 inches. The pressing may be accomplished by a manual or automatic pressing device. The pressure exerted on the mixture should be sufficient so as to form the tablet into a self-sustaining body.

Methods of delivering an active ingredient to an insect according to the present invention comprise the steps of providing a solid tablet containing the active ingredient as previously described and placing the tablet in a location where the insect may come into direct contact therewith. Preferably, the insects to which the active is being delivered are honeybees. In treating honeybees that are generally colonized in a manufactured bee hive, the tablet is preferably placed inside the hive on the exclusion grill (for keeping the queen from passing from the brood box up to the honey supers) or immediately below the exclusion grill in the brood box and on top of the brood frames. Placing the tablet proximate the exclusion grill allows for better bee contact with the tablet, thus ensuring delivery of the chemical agent to the bees.

Over the next several weeks after the tablet is placed into the hive, the bees chew and crumble the tablet exposing the active ingredient to the other bees. The crumbs fall through the brood box away from the honey supers. Preferably, the entire tablet is disintegrated in about 30-45 days. In this way, the likelihood of honey contamination is significantly reduced when compared to the use of drug laden strips or grease patties as described above and the need for follow-up work to remove the strips or patties from the hive is obviated.

### DETAILED DESCRIPTION OF THE PREFERRED EMBODIMENT

The following examples set forth preferred compositions and methods according to the present invention. It is to be understood, however, that these examples are provided by way of illustration and nothing therein should be taken as a limitation upon the overall scope of the invention.

### EXAMPLE 1

This example describes the preparation of a tablet used in control of American foulbrood in honeybees. First, 46.5 g of confectioner's sugar, 9.5 g corn meal, and 0.7 g oxytetracycline CHL are mixed until a homogeneous mixture is obtained. In all of the examples described herein, the confectioner's sugar may be replaced with impalpable or icing sugar. Next, 14 g of hydrogenated oil is heated at 60° C. until melted and then added to the composition. The composition is mixed until homogeneous. The mixture is cooled and passed through a sieve in order to produce substantially uniform granules. The granules are then sent to a pressing machine wherein sufficient pressure is applied to the mixture to obtain a self-sustaining tablet.

### EXAMPLE 2

In this example, a tablet for treatment of Varroa jacobsoni in honeybees is made. First, 37.3 g of confectioner's sugar, 18.5 g of corn meal, and 0.4 g of coumaphos is mixed until a homogeneous mixture is obtained. Next, 14 g of hydrogenated oil is heated at 60° C. until melted and then added to the composition. The composition is mixed until homogeneous. The composition is cooled and passed through a sieve in order to produce substantially uniform granules. The granules are then sent to a pressing machine wherein sufficient pressure is applied to the mixture to obtain a self-sustaining tablet.

### EXAMPLE 3

This example describes the preparation of another tablet used in the treatment of Varroa jacobsoni in honeybees. First, 37.3 g of confectioner's sugar, 18.5 g of corn meal, and 13 g of thymol is mixed until a homogeneous mixture is obtained. Next, 3 g of hydrogenated oil and 8 g of paraffin are heated at 60° C. until melted and then added to the composition. The composition is mixed until homogeneous. The composition is cooled and passed through a sieve in order to produce substantially uniform granules. The granules are then sent to a pressing machine wherein sufficient pressure is applied to the mixture to obtain a self-sustaining tablet.

### EXAMPLE 4

In this example, the efficacy of four tablets made in accordance with the present invention in treating honeybees infested with Varroa were compared to a commercially available strip Apistan™ containing Tau Fluvalinate 10.25% (CAS# 102851-06-01). The following table summarizes the composition of the four tablets made in accordance with the present invention.

TABLE 1

| | Treatment # | | | |
|---|---|---|---|---|
| | TR 1 | TR 2 | TR 3 | TR 4 |
| Hydrogenated oil | 14 g | 14 g | 3 g | 14 g |
| Paraffin | — | — | 8 g | — |
| Confectioner's sugar | 37.3 g | 37.3 g | 37.3 g | 37.3 g |
| (impalpable or icing sugar) | | | | |
| Corn meal | 18.5 g | 18.5 g | 18.5 g | 18.5 g |
| Coumaphos | 400 mg | — | — | 400 mg |
| Amitraz | — | 400 mg | — | — |
| Thymol | — | — | 13 g | — |
| Oxtretracycline | — | — | — | 700 mg |

Thirty beehives were divided into two groups, either High (H) or Low (L) depending on the level of Varroa infestation. Each of these two groups was then subdivided into five subgroups (four treatment groups and one control group) for a total of 10 subgroups. From the beginning to the end of the trial, dead Varroa mites were counted every two days. Treatment with the inventive tablets comprised placing one tablet on top of the breeding chamber. After 35 days, about 95% of the tablet was consumed. The crumbling process covered two Varroa reproductive cycles so as to eliminate the Varroa mites hiding in the brooding frame cells.

At the conclusion of the treatment, a shock treatment with gasified amitraz was applied to all bee groups. The shock treatment comprised four applications every three days for a period of 12 days. The Varroa mites killed during the shock treatment were counted. The shock treatment frequency and intervals of the shock treatment were based on the life cycle of the Varroa mites and the duration of the seal or capped cycle in which the Varroa mites are protected from the action of drugs. The number of mites killed during the shock treatment was added to the number of mites killed during treatment with the tablets (DV-Treat) to arrive at the total Varroa population (TVP). The treatment efficacy (TE) was estimated as the percentage of dead Varroa mites due to the treatments of the total population:

$$TE = \frac{DV - Treat}{TVP} \times 100$$

The average efficacy of each treatment (taking into account results from both (H) and (L) groups) is as follows:

TABLE 2

| Treatment | Treatment Efficacy (TE) |
|---|---|
| TR 1 | 97.79% |
| TR 2 | 97.87% |
| TR 3 | 97.64% |
| TR 4 | 93.83% |
| Apistan ™ strip | 93.72% |

The results demonstrate a greater efficacy in killing Varroa mites over the commercial Apistan™ strip.

We claim:

1. A solid tablet for delivering an active ingredient to an insect comprising an oil, a protein/carbohydrate material, a sweetener, and said active ingredient, said tablet being essentially free of synthetic resin material.

2. The tablet of claim 1, said tablet comprising granules that are compressed into a self-sustaining body.

3. The tablet of claim 1, said active ingredient selected from the group consisting of chemical and biological agents useful in the prevention or treatment of diseases in insects, hormones, nutrients, and combinations thereof.

4. The tablet of claim 3, said active ingredient selected from the group consisting of fumagillin, amitraz, trimethoprim, monensin, nicarbazin, metoclopramide, norfloxacin, tetracycline, chlorotetracycline, oxytetracycline, tylosin, co-ral, coumaphos, thymol, rotenone, tetramethrin, decamethrin, permethrin, deltamethrin, cypermethrin, fluvalinate, pyrethrin, oxalic acid, lactic acid, formic acid, cimiazol, essential oils and mixtures thereof.

5. The tablet of claim 1, said oil comprising a member selected from the group consisting of vegetable oils, partially hydrogenated vegetable oils, and mixtures thereof.

6. The tablet of claim 1, said protein/carbohydrate material comprising corn meal.

7. A tablet for delivering an active ingredient useful in the prevention or treatment of diseases or parasites in insects comprising:
from about 4-40% by weight of an oil;
from about 5-40% by weight of a protein/carbohydrate material;
from about 25-75% by weight of a sweetener; and
from about 0.001-25% by weight of said active ingredient.

8. The tablet of claim 7, said tablet comprising granules that are compressed into a self-sustaining body.

9. The tablet of claim 7, said tablet being essentially free of synthetic resin material.

10. The tablet of claim 7, said active ingredient selected from the group consisting of chemical and biological agents useful in the prevention or treatment of diseases in insects, hormones, nutrients, and combinations thereof.

11. The tablet of claim 10, said active ingredient selected from the group consisting of fumagillin, amitraz, trimethoprim, monensin, nicarbazin, metoclopramide, norfloxacin, tetracycline, chlorotetracycline, oxytetracycline, tylosin, co-ral, coumaphos, thymol, rotenone, tetramethrin, decamethrin, permethrin, deltamethrin, cypermethrin, fluvalinate, pyrethrin, oxalic acid, lactic acid, formic acid, cimiazol, essential oils and mixtures thereof.

12. The tablet of claim 7, said oil comprising a member selected from the group consisting of vegetable oils, partially hydrogenated vegetable oils, and mixtures thereof.

13. The tablet of claim 7, said protein/carbohydrate material comprising corn meal.

14. A method of delivering an active ingredient to an insect comprising the steps of providing a solid tablet according to claim 1 and placing said tablet in a location where the insect may come into direct contact therewith.

15. The method of claim 14, said active ingredient selected from the group consisting of chemical and biological agents useful in the prevention or treatment of diseases in insects, hormones, nutrients, and combinations thereof.

16. The method of claim 14, said tablet being placed inside a bee hive.

17. The method of claim 16, said tablet being placed in a brood box of a bee hive.

18. A method of delivering an active ingredient to an insect comprising the steps of providing a solid tablet according to claim 7 and placing said tablet in a location where the insect may come into direct contact therewith.

19. The method of claim 18, said active ingredient selected from the group consisting of chemical and biological agents useful in the prevention or treatment of diseases in insects, hormones, nutrients, and combinations thereof.

20. The method of claim 18, said tablet being placed inside a bee hive.

21. The method of claim 20, said tablet being placed in a brood box of the bee hive.
